(19) United States
(12) Patent Application Publication
(10) Pub. No.: US 2019/0105232 A1
(43) Pub. Date: Apr. 11, 2019

(54) Spring Activated Tablet Cutter

(71) Applicant: Dian Fallah, La Quinta, CA (US)

(72) Inventor: Dian Fallah, La Quinta, CA (US)

(21) Appl. No.: 16/101,252

(22) Filed: Aug. 16, 2018

Related U.S. Application Data
(60) Provisional application No. 62/606,719, filed on Oct. 6, 2017.

(51) Int. Cl. A61J 7/00; B26D 7/01; B26D 3/30

(52) U.S. Cl. CPC A61J 7/0007; B26D 3/30; B26D 7/01

(57) ABSTRACT

This invention is a tablet cutter that uses coiled spring action to ultimately hold the pill in place while being split. The tablet cutter includes a base, a cover pivotally secured to the base, a cutting blade attached to the cover and a tablet spring unit. The tablet spring unit has a coiled spring that presses against a plastic rod with a face-plate attached at the end which is moveable relative to the base and holds the tablet. The tablet spring unit allows a pill to be split when the cover is moved to a closed position.

### FIELD OF INVENTION

This invention relates to tablet cutters and specifically relates to a device for precisely and efficiently cutting a tablet.

### BACKGROUND OF INVENTION

Tablets and pills are not manufactured in dosages small enough to meet the needs of all tablet and pill consumers. A person may be prescribed one-half tablet twice a day and needs to split it into two halves. (The term tablet is used in this document to include all pills which may be split). Additionally, some find it difficult to swallow large tablets and would prefer splitting the tablet in halves or quarters before consumption.

### SUMMARY OF THE INVENTION

This invention relates to a tablet cutter that uses coiled spring action to ultimately create tension on the tablet and keep it in place to be cut evenly into halves or quarters if needed. The tablet cutter includes a base, a cover pivotally secured to the base, a cutting blade attached to the cover and the tablet spring unit. The tablet spring unit includes the coiled spring. The coil spring presses a plastic rod with a face-plate at the end which keeps the tablet in place so the tablet does not move while being split. The face-plate is pulled back with a finger and the tablet is put in front of the back-rest. Then face-plate and attached rod with coiled spring at end are slowly eased to the tablet causing the tablet to be held in place against the back-rest. When the tablet is secure, the finger is removed. The spring tension holds the tablet in place during the splitting process. The tablet spring unit allows a tablet to be split when the cover is moved into a closed position.

### DESCRIPTION OF THE DRAWINGS

FIG. 1—view of a design of a tablet splitter with the cover in an open position.

FIG. 2—view of the tablet splitter of FIG. 1 but depicting the tablet splitter with the cover in a closed position.

FIG. 3—uncovered view showing the structure of the tablet spring unit used in the tablet splitter of FIG. 1-6.

FIG. 4—view from above of the tablet splitter of FIG. 1-3 depicting step 1 in the method of use.

FIG. 5—view from above of the tablet splitter of FIGS. 1-3 depicting step 2 in the method of use.

FIG. 6—view from above of the tablet splitter of FIGS. 1-3 depicting step 3 in the method of use.

FIG. 7—view of the base of the tablet splitter of FIG. 1-6 but with the tablet spring unit structure being removed for clarity.

FIG. 8—view of the top cover of the tablet splitter of FIG. 1-6 but showing the protrusions at the bottom end of the cover that make up part of the hinge.

FIG. 9—view of the tablet splitter in a closed position from the back showing the hinge.

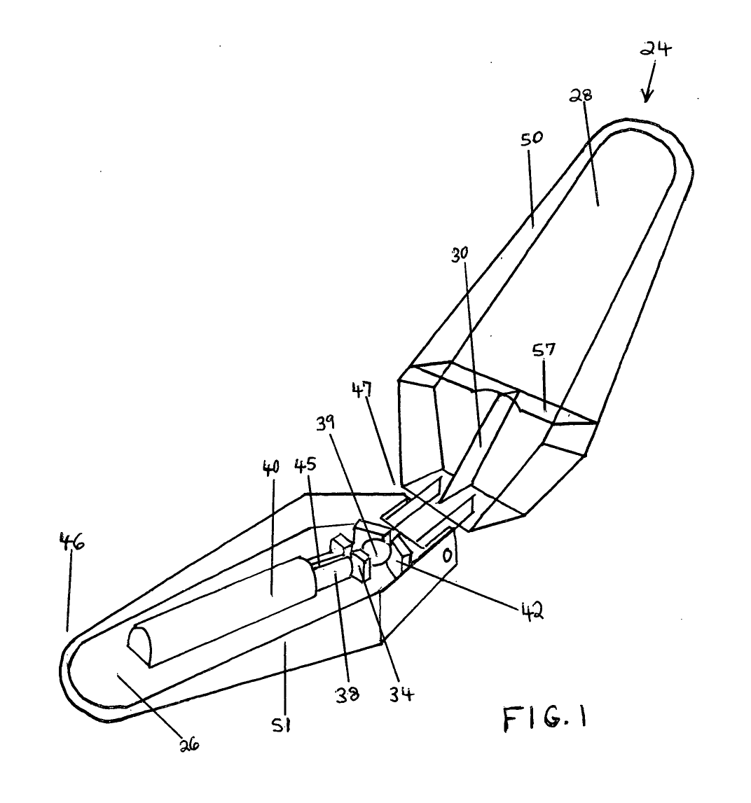

In reference to FIG. 1 a design of a tablet splitter 24 is shown. In this design the tablet splitter 24 includes a base 26 which is the portion that rests against another surface such as a table.

The cover 28 is part of the tablet splitter 24. In this design the cover 28 is pivotally secured to the base 26.

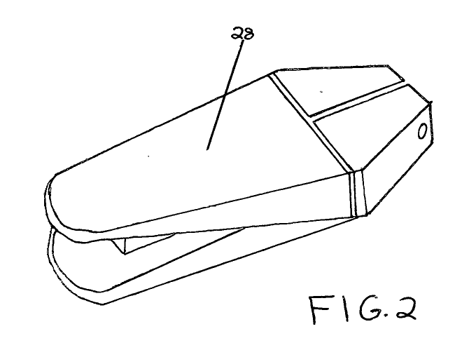

As can be seen by comparing FIGS. 1 & 2 the cover 28 is pivotal between an open position FIG. 1 and a closed position FIG. 2. In the open position, the cover 28 is away from the base 26 which exposes the internal structure of the tablet splitter 24 and the top portion of base 26, and in the closed position the base 26 is covered by the cover 28.

The tablet splitter 24 includes a cutting blade 30 (FIG. 1). In this design the cutting blade 30 is attached to the cover 28. The cutting blade 30 is to cut a tablet that is being held by base 26.

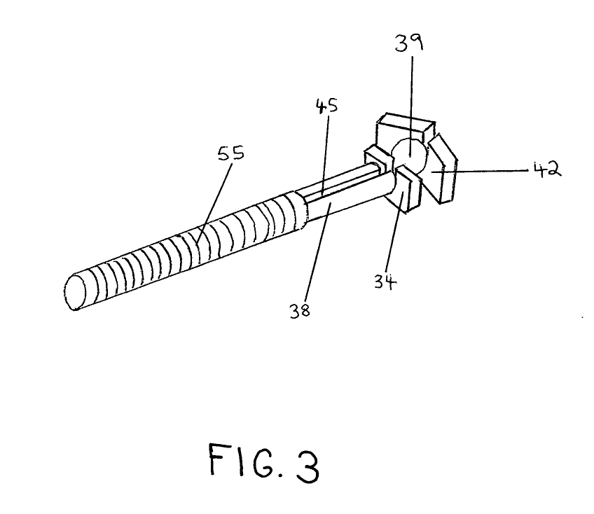

The tablet splitter 24 further includes a tablet spring unit (FIG. 3). The tablet spring unit (FIG. 3) consists of a plastic rod 38 with a spring 55 at one end and a flat-plate 34 at the other. The tablet spring unit includes flat-plate 34 for adjustably pressing on the tablet to be split. The way this is done is described in further detail below.

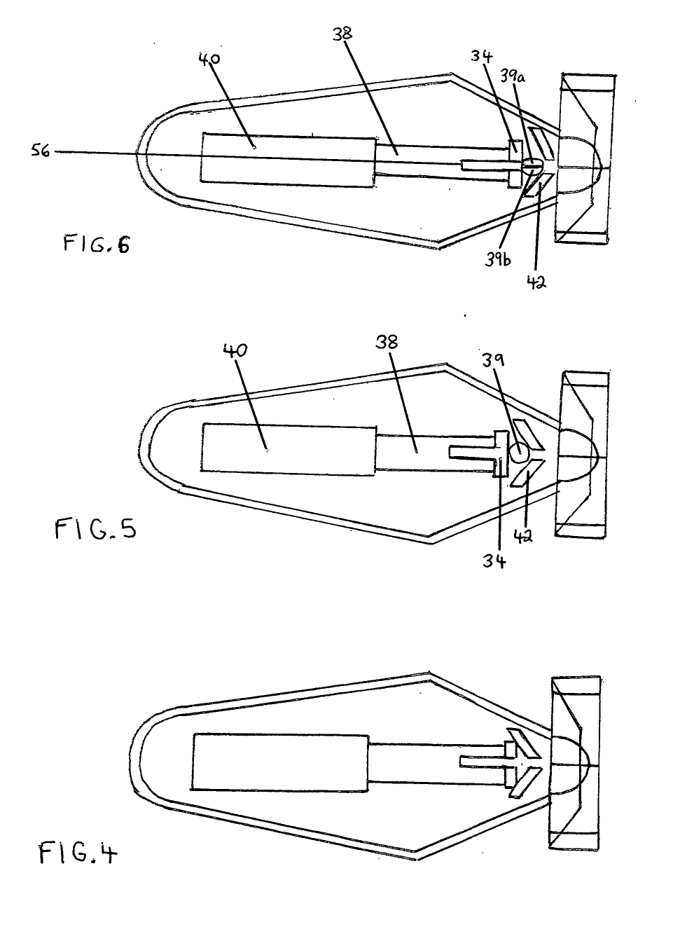

The flat-plate 34 (FIG. 3) for pressing against a tablet to be split is attached to plastic rod 38 (FIG. 3) which is attached to spring 55 (FIG. 3) which withdraws into cover 40 (FIG. 1) and this will be referred to as the tablet spring unit in future references. The tablet spring unit is moveable with spring tension, from a first position (ready to load tablet) (FIG. 4) to a second (tablet pressed) position (FIG. 5). In FIG. 5 a tablet 39 can be seen being pressed with spring action between face-plate 34 and back-rest 42, held steady in place and in alignment such that the cutter 30 bisects the tablet 39 along the longitudinal axis 56 into two equal parts 39a and 39b (FIG. 6).

In the drawings the plastic rod 38 (FIGS. 1 and 3) joins an attached flat-plate arrangement 34. The flat-plate 34 of the tablet spring unit provides a hard flat surface to hold the tablet 39 in place with pressure from the tension of spring 55. In this design the flat-plate arrangement 34 can be used as a finger tab (FIG. 1) constructed to pull back spring 55 and plastic rod 38 into cover 40. When flat-plate 34 of the tablet spring unit is pulled backward with a finger and held in place it pulls back spring 55 of the tablet spring unit, into cover 40 allowing the tablet to be placed against back-rest 42 (FIG. 1 and FIG. 3). Then the flat plate 34 is slowly eased toward the tablet with a finger and the tension from the spring rests on tablet 39 holding it in place against the back-rest 42. When the tablet is in the proper place the user slowly releases and removes their finger from the face-plate which is pressing the tablet and holds it in place to be split in half. In FIG. 6 the angle of the tablet back-rest 42 is approximately between a 40 degree angle and a 75 degree angle. This accommodates most tablets due to face-plate 34 pressing the tablet with spring tension force onto back-rest 42. (FIG. 5) (FIG. 1).

The slot 45 shown in FIG. 1 extends through the back-rest 42 (FIGS. 1 and 3), face-plate 34 and plastic rod 38 and this slot will accommodate the cutting blade 30. The tablet holder unit and cover are raised on base 26.

The plastic rod 38, spring 55 and face-plate 34 would be added during the manufacturing process.

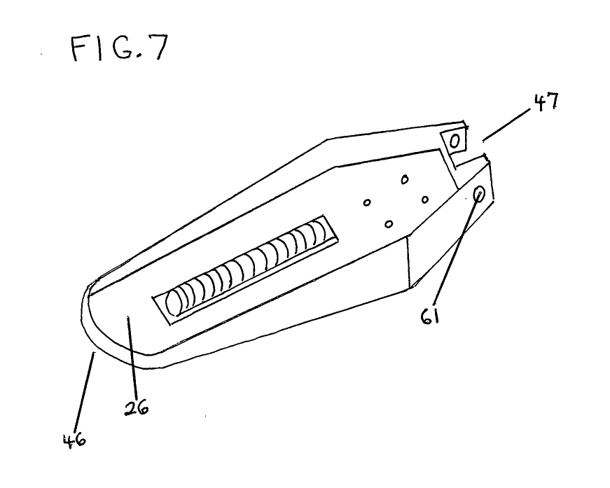

In FIGS. 1 and 7 the base 26 includes one end 46 and an opposite end 47. The end 47 is the end in which the cover is pivotally attached.

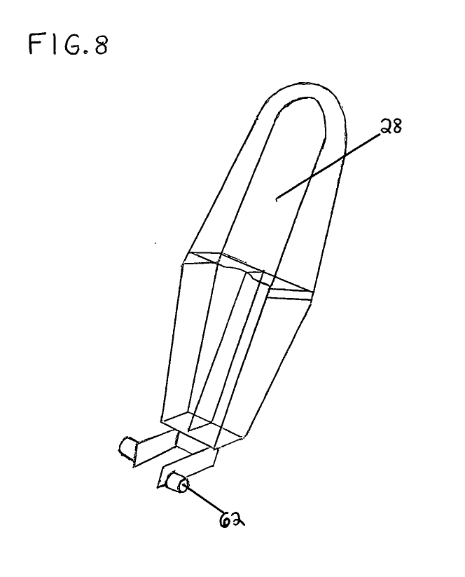

In FIG. 8 the cover 28 has two protrusions 62 at its end that fit into two holes 61 (FIG. 7) at the hinge with base 26 (FIG. 7).

In FIG. 7 the base 26 has two holes 61 at its end that accommodate protrusions 62 (FIG. 8) which are part of the hinge of cover 28 (FIG. 8).

The cover 28 has a shape sized to match the overall shape of base 26. The cover 28 has a sidewall 50 and the base 26 has a sidewall 51. The sidewalls 50 and 51 are flat horizontal edges. The sidewall 51 fits over the sidewall 50 and both close together to form a closed tablet cutter in FIG. 2.

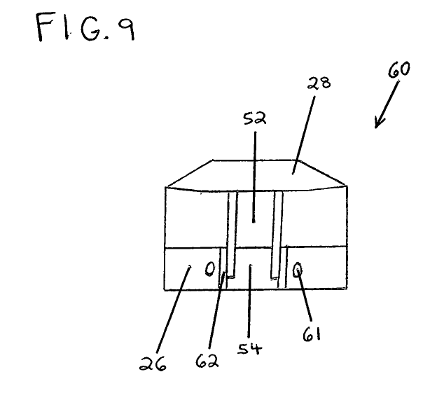

The cover 28 is pivotally attached to the base 26. In FIG. 9 it can be seen how the rear end 52 of the cover 28 is attached to the rear end 54 of the base 26 attached by a fitted plastic hinge 60 where the base 26 has two holes 61 on each side of the rear end 54 and the cover 28 has two protrusions 62 on its rear end 52 that penetrate the two holes 61 in rear end 54 of base 26.

The cutting blade 30 extends only to a portion of the inside surface of cover 28. The length of the cutting blade is 3.5 cm and extends between 30%-60% of the length of the cover 28. The cutting blade 30 is aligned with the axis 56 (FIG. 6) when the cover is in a closed position.

The cover 28 is transparent.

The tablet splitter 24 further includes a shield 57 (FIG. 1) secured to cover 28. The shield 57 is constructed to partially cover the top of the cutting blade 30 when it is in the open position.

1. A tablet cutter comprising of:
a. A base
b. A cover pivotally attached to the base
c. A cutting blade attached to the cover
d. A tablet spring unit including a coiled spring attached to a plastic rod connected to a face-plate. The face-plate is pulled back with finger and the tablet is put in front of the back-rest. Then face-plate and attached rod with coiled spring at end are moved to the tablet and slowly released, causing the tablet to be held in place with tension force from the spring, against the back-rest. The tablet is split when the cover is moved to a closed position.

2. In the tablet cutter of claim 1, the coiled spring has a cover and withdraws into the cover when face-plate is pulled back.

3. The tablet cutter of claim 1 wherein the spring provides tension force on the tablet keeping it in place while splitting.

4. The tablet cutter of claim 1 where the tablet spring unit includes:
a. A coiled spring partially under a cover
b. A plastic rod attached to the coiled spring
c. A face-plate attached to plastic rod
